(19) United States
(12) Patent Application Publication
(10) Pub. No.: US 2003/0163324 A1
(43) Pub. Date: Aug. 28, 2003

(54) System and method for voice commands recognition and controlling devices wirelessly using protocol based communication

(76) Inventor: Asim Hussain Abbasi, Cary, NC (US)

Correspondence Address: ASIM H. ABBASI, Apt. 2C, 110 Hidden Oaks Drive, Cary, NC, 27513, US

(21) Appl. No.: 10/084,071

(22) Filed: Feb. 27, 2002

(51) Int. Cl. G10L 21/00

(52) U.S. Cl. 704/275

(57) ABSTRACT

Computer based voice commands recognition and controlling pre-existing devices (Fan, Lamp etc.) in homes, factories, offices etc. wirelessly using protocol based communication between single transmitter attached with the serial port of the computer and receiver module attached with each device to be controlled.

### CROSS-REFERENCE TO RELATED APPLICATIONS

Lots of work has been done in the field of voice recognition and numerous applications, systems have been developed so far based on this technology. I like to put a reference to the following patents that contains the idea of voice commands and control,

U.S. Pat. No. 6,188,985 entitled “Wireless voice-activated device for control of a processor-based host system”

U.S. Pat. No. 5,199,080 entitled “Voice-operated remote control system”

U.S. Pat. No. 4,704,696 entitled “Method and apparatus for voice control of a computer”

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND OF INVENTION

The present invention is related to using voice recognition engine, serial port interfacing, digital protocol writing, wireless communication, microcontroller programming and design of switching circuits.

Many different companies have developed voice recognition engines along with APIs (Application Programming Interface) to allow programmers having no knowledge about DSP (Digital Signal Processing) or voice recognition to embed high quality voice recognition ability into their softwares using APIs and develop applications based on it.

Serial port interfacing describes how DTE (Data Terminal Equipment) communicates data serially using such ports on PC with DCE (Data Communication Equipment) and how to interface such ports with other electrical circuitry. Two serial ports are present in the form of DB-25 (called as Printer Port) and DB-9 in PC.

Digital protocol writing requires the knowledge of electrical as well as software engineering. By writing protocol we actually develop a Language using which different systems (software/hardware) communicates with each other.

Wireless communication describes the way to send bits into free-space through transmitter and how to capture them correctly and convert them to bits again. These days many IC chip maker have developed single chip solutions for this purpose i.e. serial data transition over a range of 100-+200 meter at a rate of 10-20 kbps and requires only PCB (Printed Circuit Board) fabricated antenna.

Microcontroller is a wonderful piece of device. U can define it as single chip computer and comprises of a processor capable of executing microcontroller specific Assembly Language, Parallel/Serial Ports, ROM (Read Only Memory), RAM (Random Access Memory), Registers (AX, BX, CX etc.), SFR (Special Function Registers) etc. Microcontroller programmers use microcontroller specific simulators to write firmware. Simulators actually provides the software simulation of microcontroller's internal working thus helps the firmware writer to debug the firmware before actually sending the code into the microcontroller ROM using emulator.

To control high voltage (120v) equipments especially inductive loads like Fan, water pump motor etc. requires special electrical circuitry to remove transients effects that result in switching of relays connected more specifically to such loads. Such circuits basically not only provides the interface between decision making device such as microcontroller and high voltage equipments but also helps to remove surges that induce in the overall electrical circuit due to switching relays.

### SUMMARY OF THE INVENTION

Using this system, the entire home devices (Lamps, Fans etc.) can be controlled through voice. The system comprises of a single PC, transmitter and receiver module attached with each device to be controlled. The user of this system will no need to move from his/her chair to turn on/off the light bulb or fan, moreover, when user has to go out from the home, there is no need for her/him to go to each room to turn off lights, fans etc. just by speaking voice commands will do all that.

We will assign each receiver module two IDs, one will be Network_ID and other will be Device_ID. These IDs are assigned by system user using dip-switches on receiver module. In a particular network, every receiver module will have same Network_ID but different Device_IDs. After doing this, we will configure and synchronize the software having embedded voice recognition engine with these receiver modules. In the software we will assign each receiver module a unique name e.g. if we have attached one receiver module with fan as a device to be controlled then system user using the software can assign a name as “FAN” to it or whatever. That name will then be used as voice command to control that device. Under running condition, when the system user will speak “FAN” in the microphone, the software will recognize that voice command and will generate the corresponding Network_ID and Device_ID for that receiver module and will then build a packet of bits containing three frames as shown in FIG. 4. That packet is then broadcasted through the transmitter attached with the serial port of the PC. Based on the protocol described in FIG. 4A, all receiver modules will receive this packet but only the desired receiver module will respond to it.

### BRIEF DESCRIPTION OF THE DRAWINGS

FIG. 1 shows the hardware setup of the voice controlled wireless system. There is a single transmitter attached with the serial port of PC and receiver module is attached with each device to be controlled.

FIG. 2 describes how the network would be if we want to implement the same system to entire home. Audio transmitter and microphone unit has to be installed in each room. There is a single audio receiver attached with microphone input on sound card of PC. Audio transmitter/receiver will work based on AM/FM technique whereas Digital transmitter/receiver will work based on ASK/FSK technique.

FIG. 3 depicts digital receiver module schematic with electric bulb attached as a device to be controlled. Two dip-switches are shown attached with the Microcontroller marked as 1 and 2. The receiver converts the signal (ASK/FSK) from transmitter back to bits. Those bits are fed to Microcontroller serially. Switching circuit receives the signal from Microcontroller and it contains a driving circuitry to control the relay.

FIG. 4A shows the protocol packet architecture used in the wireless communication between single transmitter with all receiver modules. Network_ID is transmitted first then Device ID and on last Command frame.

FIG. 4B describes the real world example of protocol packet where 4 bits are used for Network_ID frame, 8 bits are used for Device_ID frame and 4 bits are used for Command frame. In each frame, LSB (Least Significant Bit) is transmitted first.

FIG. 5 tells the working of firmware inside the Microcontroller to implement protocol. FIG. 5C shows the data read from 4-bit dip-switch meant for Network_ID, is stored in BX register, with BL containing 0011.

FIG. 5D shows the data read from 8-bit dip-switch meant for Device_ID is stored in CX register of Microcontroller having value 11100011 .

FIG. 5A depicts that data is coming into the Microcontroller in AX register serially using scheme “Serial-in, Serial-out”. Microcontroller will first look for Network_ID and perform a comparison between AL and BL after in-taking each bit.

FIG. 5B shows that after having a Network_ID match, the Microcontroller will intake 4 bits and then perform the comparison between AX and CX

FIG. 5E shows that after having Device_ID match, the Microcontroller will intake 4 bits and check AH. If its contents are 0001 then it means, command to turn-on the attached device (e.g. Electric Bulb) and if its contents are 0000 then it means, command to turn-off the attached device.

### DETAILED DESCRIPTION OF THE INVENTION

This system consists mainly of four parts, software (runs on PC), transmitter, receiver (containing firmware in Microcontroller) and protocol. All of them are discussed one by one in the following paragraphs.

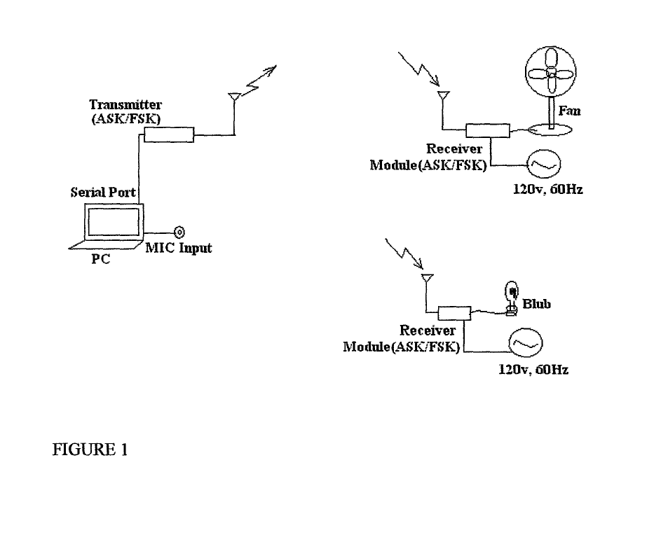

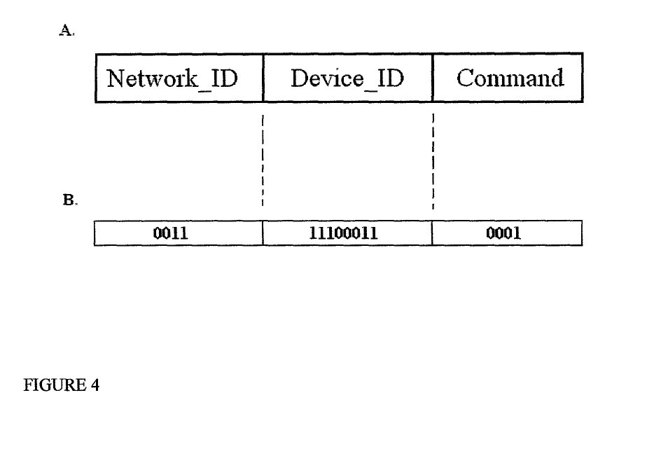

Software will run on the PC and having voice commands recognition ability and assigning each device to be controlled a unique name (e.g. Fan, Lamp etc. or whatever as desired by the system user). When the system user wants to turn on the fan, he just has to say “Fan” in the microphone attached with the PC as shown in FIG. 1. Protocol has been developed and implemented in this system that describes how single transmitter will communicate with the receiver module attached with each device to be controlled. Based on this protocol, software will send three frames of bits namely, Network_ID, Device_ID and Command as shown in FIG. 4A to the transmitter attached with the serial port of the PC.

Transmitter attached with the serial port of the PC will transmit those pulses based on the ASK (Amplitude Shift Keying) technique. Baud rate of serial port must be matched or at least less than max baud rate of the transmitter. There are chips from different brands that are single chip transmitter meant to be used with the serial port and provides a range of 100+ meters with baud rate of 10 or 20 kbits/sec or even more. As in our case, we just want to turn devices on or off so having a system with baud rate of 10 kbits/sec is more than enough.

Receiver module attached with each device (Fan, Lamp etc.) will receive those signals and convert them back to bits. There must be two dip-switches (4/8 bits or whatever depends upon the number of devices to be controlled) on the receiver. One is meant for setting the Network_ID of the receiver and other for Device_ID.

Protocol comprises of three frames of bits as shown in FIG. 4A and describes the way how software after recognizing the voice command will broadcast the command through the transmitter and how only the desired receiver will respond to that command.

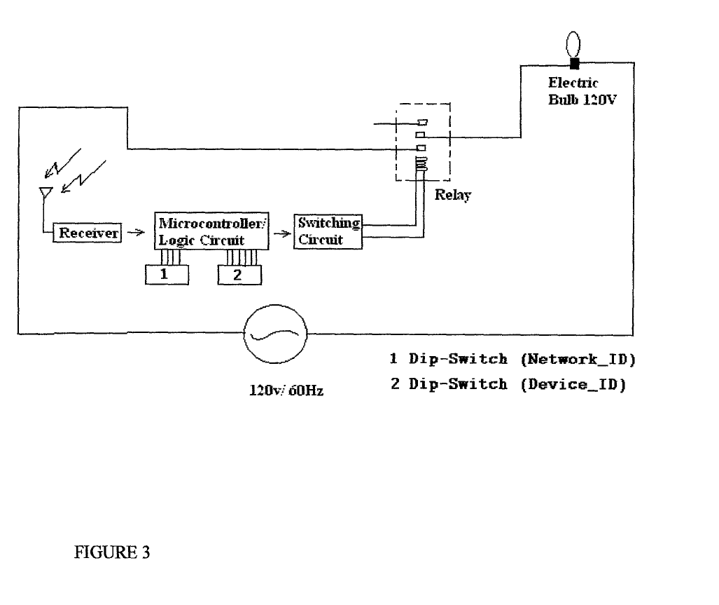

Lets me first start with receiver module. The receiver module is shown in the FIG. 3 with electric bulb attached. As is depicted in the FIG. 3, the receiver module will contain two dip-switches. Using one we can assign Device_ID to that receiver so that it can recognize that this command sent by transmitter is for it to execute. Other will be used to assign the Network_ID e.g. if u want to control 12 devices using same transmitter then all receiver modules attached with each device would have same Network ID (same dip-switch setting) but each would be having its own unique Device ID (different dip-switch setting). If u want to design the system to control 256 devices then u will require 8-bits dip-switch for allotting each device a unique Device_ID. Similarly if u have two or more such networks running in the vicinity of each other then for each receiver module to identify its own network transmitter, we will need dip-switch of more than 2 bits on the each receiver module.

Either FSK (Frequency Shift Keying) or ASK (Amplitude Shift Keying) or any other method of sending digital date can be used through transmitter. The receiver will receive those waves converts them back to bits and those bits will be read by Microcontroller through serial port.

Transmitter will first send the Network_ID with least significant bit first. Receiver modules will first check whether it is a call from the transmitter on their network or some other network by comparing the Network_ID set on the receiver using dip-switch with the one it received from the transmitter. If both are same then it will look for the Device_ID and compares the one it received from the transmitter with the one system user allotted using dip-switch on the receiver. If Device_ID comparison also results in a match then the Microcontroller will look for the Command frame. If it is 0001 then it will turn on the attached device and if it is 0000 then it will turn it off.

Now consider a network as shown in FIG. 1 with one receiver module attached with the fan and other one with the electric bulb. Lets suppose we have set the dip-switch meant for Network_ID as 0011 on both the receiver modules since both are to be controlled by same transmitter and Device_ID for electric bulb as 11100011 and for fan as 11000011 using dip-switch meant for setting Device_ID. Both of these dip-switches are depicted in FIG. 3. After running the software on the PC, system user will first configure and synchronize the software with the transmitter and receiver modules by first entering the Network_ID as set on each receiver module. Then system user will enter the Device_ID of each receiver module and assign each device a name, which will become the voice command for that device e.g. if the receiver having Device_ID of 11100011 is attached with a electric bulb then system user will write BULB (or whatever name he wants to assign to that device) in the name text box next to Device_ID of the 11100011. In the same manner system user will enter the Device_ID of each receiver module and assign a unique name to each device.

When the system user will activate the software and will speak BULB in the microphone, the voice recognition engine embedded in the software will recognize the voice command and software will then come to know which Device_ID system user wants to toggle (turn On/Off). The software will then build three frames of bits as shown in FIG. 4B and will send it to transmitter for broadcast. All receiver modules attached with each device will receiver those bits but only the desired receiver module will execute the command.

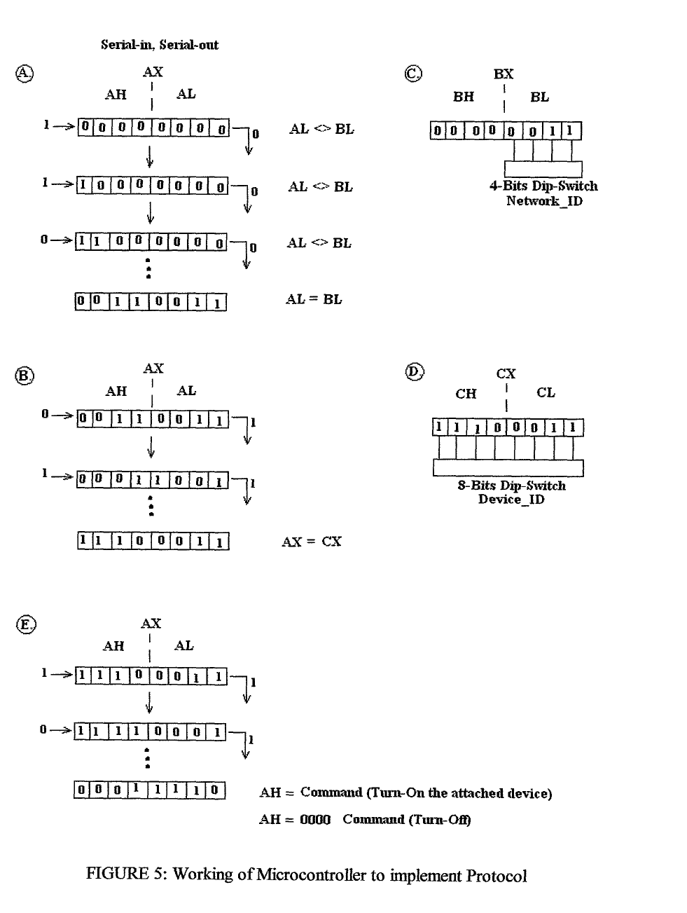

In the receiver module, the received signal from transmitter is converted back to bits and those bits are fed to Microcontroller serially. The working of firmware in Microcontroller is explained in FIG. 5. As shown in FIG. 5C, the dip-switch data meant for Network_ID is saved in BX register with BL containing 0011 and the dip-switch data meant for Device_ID is saved in CX register as shown in FIG. 5D having value 11100011. The received data is fed serially to AX register of Microcontroller with scheme “Serial-in, Serial-out” e.g. as shown in FIG. 5A, 1 will take the position of MSB (Most Significant Bit) and reset of the data in the register is shifted to the right one bit with LSB (Least Significant Bit: in this case 0) is taken out of the register.

The Microcontroller will first look for Network_ID and will run the comparison routine after each bit in-take into the AX register. It will keep comparing the value in the AL register with the value in the BL register as shown in FIG. 5A after each bit intake, unless a match is found. If the match is found, then the Microcontroller will look for Device_ID and will intake 4 bits the same way but without comparing the data in AX with data in CX after each bit intake. Because when AL results in a match with BL, the value in AH actually contains the 4 bits of Device_ID frame. After 4 bits intake, the Microcontroller will then perform the comparison between AX and CX as shown in FIG. 5B. If the match is found, then the Microcontroller will look for Command frame otherwise it will go back to main routine of looking for Network_ID, as this is not the command for it.

If AX and CX results in a match as in FIG. 5B, then the Microcontroller will look for Command frame and will intake 4 bits and will check the content of AH as shown in FIG. 5C. If it is 0001 then its a command to turn on the attached device and if it is 0000 then its a command to turn off the attached device. Based on the information in the AH register, Microcontroller will then send the order to the switching circuit meant for driving relay as shown in FIG. 3.

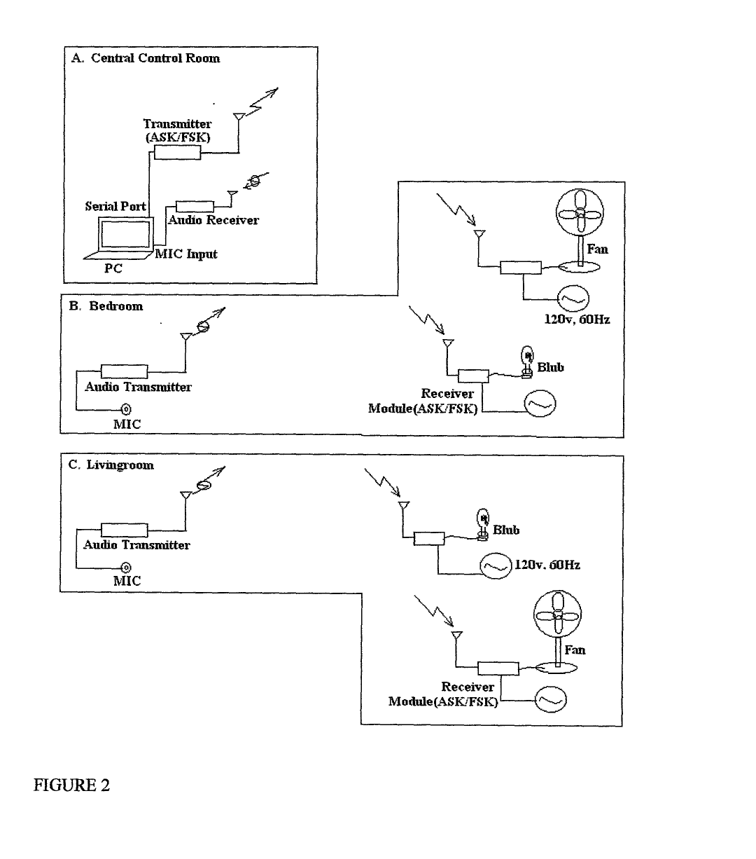

If we have to extend the same system for complete home then we have to use one audio transmitter/receiver (using AM/FM technique) as well, as shown in FIG. 2. One microphone and audio transmitter module is installed in each room. When the system user will speak “Bedroom Fan”, the audio signal is transmitted and will receive by audio receiver attached with the microphone input of PC as shown in FIG. 2. The voice engine embedded in the software will then recognize this voice command and software will build the frames based on the Device_ID related to voice command, “Bedroom Fan”. Those frames of bits are broadcasted through the transmitter. Based on that protocol as shown in FIG. 4A only the desired device will respond to the voice command.

What I claim as my invention is:

1. A wireless system through which devices (Fan, Lamp etc.) are controlled through voice, comprising:
software that runs on the PC and has embedded voice recognition engine;
a transmitter that is attached with the serial port of PC running said software;
a receiver module is attached with the each device to be controlled;
a protocol using which said software after recognizing the voice command will communicate through single said transmitter with said receiver module attached with each device to be controlled;
a microphone attached with sound card of the said PC.

2. The system of claim 1, wherein said receiver module has two dip-switches, one meant for setting Network_ID and must be same for all the wherein said receiver modules in a system, other meant for setting the Device_ID and must be unique for each wherein said receiver module.

3. The system of claim 1, wherein said receiver module comprising:
A receiver operating on FSK/ASK technique and has the ability to convert the signal received from wherein said transmitter into the bits;
A microcontroller receives those said bits serially;
A firmware in said microcontroller rom is used for the implementation of wherein said protocol; and
switching circuit which receives order from said Microcontroller and drives the relay for turning wherein said devices on/off.

4. The system of claim 1, wherein said transmitter broadcasts bits received from wherein said software through serial port based on FSK/ASK technique.

5. The system of claim 1, wherein said protocol comprising of three frames of bits;
first frame is wherein said Network_ID;
second is wherein said Device_ID; and
last is Command.

6. The system of claim 1, wherein said software is to be configured before use, with the wherein said receiver modules in the system by entering first the wherein said Network ID, second the wherein said Device ID on each said receiver module and last assigning each said receiver module with a name; said name will then be used as a voice command for that said receiver module.

7. The system of claim 1, where in said microphone is used to convert the wherein said voice commands spoken by system user into electrical signal.

8. The system of claim 1, wherein said software will build wherein said protocol based on the voice command recognized and corresponding wherein said Device_ID identified;
said software will then send first the wherein said Network_ID with LSB (Least Significant Bit) first; second the wherein said Device_ID with LSB first and last the wherein said Command with LSB first to the wherein said transmitter for broadcast.

9. The system of claim 3, wherein said firmware utilizes three registers of wherein said microcontroller for wherein said protocol implementation;
AX register for serial data coming into the said microcontroller after being converted into bits by the wherein said receiver in the wherein said receiver module;
BL register will be used to store the value of wherein said dip-switch meant for setting wherein said Network_ID on the wherein said receiver module in case we are using 4-bit dip-switch;
CX register will be used to store the value of wherein said dip-switch meant for setting wherein said Device ID on the wherein said receiver module in case we are using 8-bit dip-switch.

10. The system of claim 9, wherein said AX register will operate on “Serial-in, Serial-Out” scheme i.e.
said AX register will intake bit from wherein said receiver in the wherein said receiver module and places it at MSB (Most significant Bit) position after shifting its content to the right by one bit and dropping the LSB out.

11. The system of claim 3, wherein said firmware will first look for wherein said Network_ID; said firmware will perform a comparison of wherein said AL with wherein said BL after intake of each bit, in case we are using 4-bit wherein said Network_ID;
if match is found between AL and BL then the said firmware will look for wherein said Device_ID; said firmware will then intake 4 bits using the same wherein said “Serial-in, Serial-Out” scheme and then compares wherein said AX with wherein said CX register, in case we are using 8-bit wherein said Device_ID;
if the match is not found then said firmware will go back to previous routine of looking for wherein said Network_ID;
if match is found between said AX and CX then the said firmware will look for wherein said Command frame; said firmware will then intake 4 bits using the same said “Serial-in, Serial-Out” scheme and then checks the contents of AH in case we are using 4-bit said Command frame;
if said AH register contents are 0001, it means to turn on the wherein said device attached with the wherein said receiver module;
if said AH register contents are 0000, it means to turn off the said device attached with the said receiver module;
based on the content of said AH register, wherein said Microcontroller will send order to wherein said switching circuit to either turn on or turn off the attached said device.

12. A wireless system through which devices (Fan, Lamp etc) are controlled through voice, comprising:
Software that runs on the PC and has embedded voice recognition engine;
a transmitter that is attached with the serial port of PC running said software;
receiver module attached with the each device to be controlled;
a protocol using which said software after recognizing the voice command will communicate through single said transmitter with said receiver module attached with each device to be controlled;
audio receiver attached with the microphone input of the sound card in the said PC, used to demodulate the audio signal;
audio transmitter module.

13. The system of claim 12, wherein said audio transmitter module comprises:
a microphone used to convert spoken voice commands into electrical signal;
a audio transmitter that transmits the voice command using technique FM/AM;

14. The system of claim 12, wherein said audio transmitter module is placed in every room of a house; when user will speak any voice command, said audio transmitter will transmit it.

15. The system of claim 12, wherein said, audio receiver will demodulate the signal received from the wherein said audio transmitter module.

16. The system of claim 1, wherein said protocol comprising of three frames of bits;
first frame is wherein said Network_ID;
second is wherein said Device_ID; and
last is Command.

17. The system of claim 12, wherein said software will build wherein said protocol based on the voice command recognized and corresponding wherein said Device_ID identified;
said software will then send first the wherein said Network_ID with LSB (Least Significant Bit) first; second the wherein said Device_ID with LSB first and last the wherein said Command with LSB first to the wherein said digital transmitter for broadcast.

18. The system of claim 12, wherein said receiver module will first look for wherein said Network ID, if mach is found with the said Network_ID on the said receiver module then it will look for wherein said Device_ID if a match is found with the said Device_ID on the receiver module then it will check the Command frame;
said Command frame will either be 0001 for turning on the attached wherein said device to be controlled or 0000 for turning off the attached said device.
